(19) United States
(12) Patent Application Publication
(10) Pub. No.: US 2004/0213896 A1
(43) Pub. Date: Oct. 28, 2004

(54) Conductive pattern forming composition, formation method of conductive pattern and production method of conductive pattern forming composition

(75) Inventors: Kazuyoshi Shioiri, Kyouto-shi (JP); Tetsuya Yoshida, Tokyo (JP); Yuusuke Kawahara, Tokyo (JP); Kazuyoshi Ichikawa, Tokyo (JP)

Correspondence Address: MUSERLIAN AND LUCAS AND MERCANTI, LLP, 475 PARK AVENUE SOUTH, NEW YORK, NY, 10016, US

(73) Assignee: Konica Minolta Holdings, Inc., Tokyo (JP)

(21) Appl. No.: 10/828,960

(22) Filed: Apr. 20, 2004

(30) Foreign Application Priority Data
Apr. 24, 2003 (JP) 2003-120092

(51) Int. Cl. B05D 5/12

(52) U.S. Cl. 427/58; 427/180; 427/258

(57) ABSTRACT

A conductive pattern forming composition, containing in a dispersion medium conductive fine particles composed of at least one kind of metal and a dispersant for dispersing the conductive fine particles, wherein the dispersant is a polymer containing a tertiary amine-type monomer in a main chain and a polyether-type nonionic monomer in a side chain.

### BACKGROUND OF THE INVENTION

1. Field of the Invention

The present invention relates to a conductive pattern forming composition for forming a conductive pattern on a substrate, a production method of the conductive pattern forming composition and a formation method of the conductive pattern.

2. Description of Related Art

A conventional technology for forming a conductive pattern on a surface of a substrate includes a technology where a droplet pattern comprising droplets of a conductive pattern forming composition is formed on the surface of the substrate by an ink jet system and the droplet pattern is heated to form a conductive pattern (see, e.g., Japanese Patent Application Publication-Tokukai-2002-134878).

In the conductive pattern forming composition used in such a technology, micronized conductive fine particles are incorporated in a dispersed state, and the conductive fine particles are heated and fused on the surface of the substrate to form the conductive pattern (see, e.g., Japanese Patent Application Publication-Tokukaihei-11-80647).

Incidentally, it has recently been desired to form a fine conductive pattern by use of minute conductive fine particles, in order to increase a packaging density of a conductive pattern on a substrate. However, there is a problem that when micronizing conductive fine particles in the conductive pattern forming composition, the conductive fine particles are aggregated.

### SUMMARY OF THE INVENTION

An object of the present invention is to provide a conductive pattern forming composition capable of increasing a packaging density of a conductive pattern on a substrate, a formation method of the conductive pattern and a production method of the conductive pattern forming composition.

In accordance with a first aspect of the invention, the conductive pattern forming composition contains in a dispersion medium conductive fine particles composed of at least one kind of metal and a dispersant for dispersing the conductive fine particles, wherein the dispersant is a polymer containing a tertiary amine-type monomer in a main chain and a polyether-type nonionic monomer in a side chain.

According to the conductive pattern forming composition, a dispersant contained in the conductive pattern forming composition is a polymer containing a tertiary amine-type monomer in the main chain and a polyether-type nonionic monomer in the side chain, so that the conductive fine particles can be dispersed with no aggregation in the conductive pattern forming composition by using the dispersant as a protective colloid. Therefore, a fine conductive pattern can be formed by use of a minute conductive fine particle as compared with that in conventional techniques, so that a packaging density of the conductive pattern on the substrate can be increased. In addition, the conductive fine particles in the conductive pattern forming composition can be made minute, so that by heating at a temperature lower than that in conventional techniques, conductivity can be imparted to a droplet pattern drawn on the surface of the substrate by the droplets of the conductive pattern forming composition.

Preferably, listed as the metal may be copper or noble metals. Listed as the noble metals may be gold, silver, ruthenium, rhodium, palladium, osmium, iridium and platinum.

The composition is preferably used for forming a conductive pattern on a surface of a substrate by an ink jet system.

According to this construction, the conductive pattern forming composition is a composition for forming the conductive pattern on the surface of the substrate by use of the ink jet system and the conductive fine particle in the conductive pattern forming composition are made minute as compared with that in conventional techniques, therefore, clogging of nozzles which eject the conductive pattern forming composition is hardly caused. Consequently, the conductive pattern can be easily formed as compared with the conventional techniques.

In the composition, preferably, the conductive fine particles comprise copper.

According to such a construction, the conductive fine particle is composed of copper, so that the conductive fine particles in the conductive pattern forming composition can be surely dispersed by a dispersant.

Preferably, in the composition, the conductive fine particles have an average particle size of not less than 0.1 nm and not more than 20 nm.

According to such a construction, an average particle size of the conductive fine particle is not less than 0.1 nm and not more than 20 nm, so that a fine conductive pattern can be formed.

The dispersion medium is preferably an organic dispersion medium mainly composed of a water-insoluble organic solvent.

According to such a construction, the dispersion medium is an organic dispersion medium mainly composed of a water-insoluble organic solvent, so that the conductive fine particle can be stably held in a dispersed state with the aid of a dispersion effect and a microbrownian motion by a dispersant.

In accordance with a second aspect of the invention, the method for forming a conductive pattern comprising: drawing a droplet pattern on a surface of a substrate by droplets of the composition of the first aspect, and heating the droplet pattern drawn in the drawing to impart conductivity to the droplet pattern.

According to the formation method of the conductive pattern, the droplet pattern drawn by droplets of the conductive pattern forming composition is heated to impart conductivity to the droplet pattern, whereby the droplet pattern can be formed into a conductive pattern.

In the drawing step, the droplet pattern is preferably drawn by ejecting droplets of the conductive pattern forming composition by an ink jet system.

According to such a construction, because the droplet pattern is drawn by use of the ink jet system, a fine droplet pattern can be easily drawn.

In the drawing step, the droplets of the conductive pattern forming composition are preferably ejected from a nozzle having a nozzle size of 0.1 μm to 10 μm.

According to such a construction, because the droplets of the conductive pattern forming composition are ejected from a nozzle having a nozzle size of from 0.1 μm to 10 μm, a fine droplet pattern can be formed.

In the drawing step, a droplet pattern having a line width of 20 μm or less is preferably drawn.

According to such a construction, a fine droplet pattern can be formed.

In accordance with a third aspect of the invention, the method for producing a conductive pattern forming composition, comprises reducing a metal compound having at least one kind of metal in an aqueous dispersion medium containing a dispersant to obtain conductive fine particles, wherein a polymer containing a tertiary amine-type monomer in a main chain and a polyether-type nonionic monomer in a side chain is used as the dispersant.

According to the production method of the conductive pattern forming composition of the present invention, a polymer containing a tertiary amine-type monomer in the main chain and a polyether-type nonionic monomer in the side chain is used as the dispersant, whereby the conductive fine particles can be dispersed with no aggregation in the conductive pattern forming composition by using the dispersant as a protective colloid. Therefore, a fine conductive pattern can be formed by use of a minute conductive fine particle as compared with that in conventional techniques, so that a packaging density of the conductive pattern on the substrate can be increased. In addition, the conductive fine particle in the conductive pattern forming composition can be made minute, so that by heating at a temperature lower than that in conventional techniques, conductivity can be imparted to a droplet pattern drawn on the surface of the substrate by the droplets of the conductive pattern forming composition.

In the reducing step, an organic amine compound may be used as a reducing agent.

According to such a construction, the reduction step is performed by employing the organic amine compound as the reducing agent, whereby a metal compound can be reduced under relatively weak reducing conditions. Therefore, dispersion in a particle size of the precipitated conductive fine particles can be reduced and moreover, progress of an oxidation reaction can be made difficult. Further, unlike the case of performing the reduction using poisonous hydrazine, etc., the reduction step can be performed under the conditions reduced in harmfulness.

Herein, when the reducing conditions such as type of reducing agent or temperature are strong, dispersion in the particle size of the precipitated conductive fine particles is increased and moreover, the oxidation reaction is facilitated. Therefore, the reducing conditions are preferably weaker.

In the reducing step, a temperature of the aqueous dispersion medium may be adjusted to 20° C. to 60° C.

In this way, the temperature of the aqueous dispersion medium in the reduction step is adjusted to 20° C. to 60° C., whereby the reduction step can be performed under the safe conditions, unlike the case of performing the reduction under the high temperature conditions of 200° C. or more.

Preferably, the method further comprises: interphase transferring the conductive fine particles and the dispersant from an aqueous dispersion medium phase to an organic dispersion medium phase which is mainly composed of a water-insoluble organic solvent, after the reducing.

According to this construction, the conductive fine particles and the dispersant are allowed to undergo interphase transfer from the aqueous dispersion medium phase to the organic dispersion medium phase in the presence of the dispersant, whereby the conductive fine particles can be extracted into the organic dispersion medium phase in a dispersed state with no aggregation. Therefore, the conductive fine particles can be shielded against oxygen, that is, the conductive fine particles can be hardly oxidized, unlike the case in the aqueous dispersion medium phase.

The method may further comprise purifying to remove at least a part of water soluble components in the organic dispersion medium phase by use of purified water, after the interphase transferring.

According to such a construction, the purification step is performed, whereby a part of the reducing agent and the dispersant can be removed. Therefore, when the droplet pattern drawn by the droplets of the conductive pattern forming composition is heated, the conductive fine particles can be surely fused with each other, that is, conductivity can be surely imparted to the droplet pattern.

In accordance with a fourth aspect of the invention, the method for producing a conductive pattern forming composition, comprises interphase transferring a dispersant and conductive fine particles composed of at least one kind of metal from an aqueous dispersion medium phase containing the dispersant and having dispersed therein the conductive fine particles to an organic dispersion medium phase mainly composed of a water-insoluble organic solvent, wherein a polymer containing a tertiary amine-type monomer in a main chain and a polyether-type nonionic monomer in a side chain is used as the dispersant.

According to the production method of the conductive pattern forming composition of the present invention, the conductive fine particles and the dispersant are allowed to undergo interphase transfer from the aqueous dispersion medium phase to the organic dispersion medium phase in the presence of the dispersant, whereby the conductive fine particles can be extracted into the organic dispersion medium phase in a dispersed state with no aggregation. Therefore, the conductive fine particles can be shielded against oxygen, that is, the conductive fine particles can be hardly oxidized. Further, a fine conductive pattern can be formed by use of a minute conductive fine particle as compared with that in conventional techniques, so that a packaging density of the conductive pattern on the substrate can be increased. In addition, the conductive fine particle in the conductive pattern forming composition can be made minute, so that by heating at a temperature lower than that in conventional techniques, conductivity can be imparted to a droplet pattern drawn on the surface of the substrate by the droplets of the conductive pattern forming composition.

In the interphase transferring step, a temperature of the aqueous dispersion medium phase and the organic dispersion medium phase is preferably adjusted to 50° C. to 90° C.

According to such a construction, the temperature of the aqueous dispersion medium and the organic dispersion medium is adjusted to 50° C. to 90° C., whereby the conductive fine particles and the dispersant can be allowed to undergo interphase transfer from the aqueous dispersion medium phase to the organic dispersion medium phase in a stable state.

In the interphase transferring, a pH of the aqueous dispersion medium is preferably adjusted to 7 to 10.

According to such a construction, the pH of the aqueous dispersion medium is adjusted to 7 to 10, whereby the conductive fine particles and the dispersant can be allowed to undergo interphase transfer from the aqueous dispersion medium phase to the organic dispersion medium phase in a stable state.

The method may further comprises purifying to remove at least a part of water soluble components in the organic dispersion medium phase by use of purified water, after the interphase transferring.

According to this construction, the purification step is performed, whereby a part of the reducing agent and the dispersant can be removed. Therefore, when the droplet pattern drawn by the droplets of the conductive pattern forming composition is heated, the conductive fine particles can be surely fused with each other, that is, conductivity can be surely imparted to the droplet pattern.

### BRIEF DESCRIPTION OF THE DRAWINGS

The present invention will become more fully understood from the detailed description given hereinbelow and the appended drawings which given by way of illustration only, and thus are not intended as a definition of the limits of the present invention, and wherein;

FIG. 1 is a longitudinal sectional view showing a circuit board.

### PREFERRED EMBODIMENTS OF THE INVENTION

Hereinafter, the embodiments of the present invention will be described by referring to the drawing.

The conductive pattern forming composition of the present invention is one for forming a conductive pattern on a surface of a substrate by an ink jet system and the like, and contains conductive fine particles and a dispersant for dispersing the conductive fine particles in a dispersion medium.

The dispersion medium is mainly composed of a water-insoluble organic solvent, specifically, MEK (methyl ethyl ketone), MIBK (methyl isobutyl ketone), ethyl acetate, butyl acetate, toluene, xylene, etc.

The conductive fine particle is composed of at least one kind of metal. In the embodiment, the particle is composed of copper. The conductive fine particle has an average particle size of not less than 0.1 nm and not more than 20 nm.

The dispersant is an oligomer having a comb shape in which a plurality of the side chains are connected to the main chain like comb teeth, and is formed from a plurality of monomers radically polymerized by solution polymerization and the like. This dispersant has a weight average molecular weight of from 3,000 to 100,000.

More specifically, the dispersant is a graft polymer in which other kind of monomers as the side chain are arrayed here and there in the monomer unit as the main chain, and also is a block polymer formed by continuous polymerization of plural kinds of respective monomers.

In the main chain of the dispersant, a nitrogen-containing tertiary amine-type monomer such as dimethylaminoethyl (meth)acrylate and diethylaminoethyl (meth)acrylate is contained as a copolymerization component. Consequently, the dispersant provides an electron from a nitrogen atom in a portion derived from the tertiary amine-type monomer so as to stably hold a conductive fine particle, namely, to disperse a conductive fine particle.

Further, in the main chain of the dispersant, (meth)acrylic acid or a derivative thereof is preferably contained, other than the above-described nitrogen-containing tertiary amine-type monomer. In this case, the monomer can be surely subjected to radical polymerization.

Further, in the main chain of the dispersant, styrene or a long-chain alkyl group such as a stearyl group is preferably contained. In this case, the dispersant can surely disperse conductive fine particles in an organosol system. Listed as the long-chain alkyl group are alkyl (meth)acrylate, 2-ethylhexyl (meth)acrylate, lauryl (meth)acrylate, stearyl (meth)acrylate, etc.

Further, in the main chain of the dispersant, glycidyl (meth)acrylate, a primary amine derivative of glycidyl (meth)acrylate, a polyethylene imine derivative of glycidyl (meth)acrylate, a polyethyleneimine adduct to poly(meth)acrylic acid, 2-hydroxyethyl (meth)acrylate, 2-hydroxypropyl (meth)acrylate, etc are preferably contained as a reactive monomer to the conductive fine particles. In this case, the dispersant is effectively adhered to the conductive fine particles, whereby the conductive fine particles can be dispersed.

Further, a polyether-type nonionic monomer component is contained in the side chain of the dispersant. Specifically, a hydrophilic polyethylene oxide and a hydrophobic polypropylene oxide or polybutylene oxide are contained in the side chain of the dispersant.

With the aid of these side chain components, the dispersant effectively exerts a dispersion effect of the conductive fine particles. Further, since the dispersant contains the hydrophilic component and the hydrophobic component in the side chain components as described above, a micro-domain structure is formed in the dispersion medium. Further, in the dispersant, the number of additional mole of ethylene oxide or propylene oxide can be freely controlled, so that an effect of dispersing the conductive fine particles can be exerted or a monomer having excellent stability against changes in temperature or pH and excellent compatibility with the dispersion medium can be formed. Further, in the dispersant, when a molecular chain having large flexibility is added to the side chain component, a surface of the conductive fine particle is covered with the molecular chain to form an adsorption layer, whereby dispersibility of the conductive fine particle can be improved and moreover, the system can be stabilized. Further, in the production step of the conductive pattern forming composition as described later, the dispersant allows a dispersion medium comprising a mixture of an organic dispersion medium and an aqueous dispersion medium to become a state of being completely separated into two layers from a state of an organic dispersion medium-aqueous dispersion medium uniform phase or a microemulsion.

Next, the production method of the conductive pattern forming composition according to the present invention will be described.

First, into a flask in a water bath, isopropyl alcohol as a solvent, the monomer components of a dispersant and azoisobutyronitrile as a polymerization initiator are put and they are subjected to solution polymerization, whereby a plurality of monomers are radically polymerized to synthesize the dispersant.

Next, a metal compound such as copper and the dispersant are dissolved in an acidic aqueous dispersion medium. The dispersant has a tertiary amino group and therefore, is increased in solubility in the acidic aqueous dispersion medium. Herein, examples of the copper compound include copper formate, copper acetate, copper naphthenate, copper octylate, copper acetylacetonate, copper chloride, copper sulfate and copper nitrate. Among these, inexpensive copper sulfate or copper nitrate is preferably employed.

Next, a copper ion in the aqueous dispersion medium phase is reduced, whereby a conductive fine particle is formed (reduction step). Specifically, to the aqueous dispersion medium, an organic amine such as a primary amine or a secondary amine is added with stirring under a normal temperature, whereby the copper ion is reduced and precipitated in the aqueous dispersion medium phase. Herein, since the dispersant exists in the aqueous dispersion medium phase, precipitated conductive fine particles are stably dispersed in the aqueous dispersion medium phase by using the dispersant as a protective colloid and the conductive fine particle has a particle size of not less than 0.1 nm and not more than 20 nm. Further, when the reduction step is performed using an organic amine compound as a reducing agent, the copper ion is reduced under relatively weak reduction conditions and therefore, dispersion in a particle size of the precipitated conductive fine particles is reduced. As the organic amine added to the aqueous dispersion medium, preferred is alkanolamine such as methylaminoethanol, ethanolamine, propanolamine and diethanolamine, and more preferred is polyethylene imine. When polyethylene imine is used, the copper ion can be reduced and moreover, precipitated conductive fine particles can be dispersed. Incidentally, polyethylene imine may be one contained in a polymer as the side chain. Specifically, preferred is one contained, as the side chain, in a graft polymer containing a (meth)acrylic acid derivative as the main chain component.

Next, the aqueous dispersion medium having dispersed therein conductive fine particles is brought into contact with an organic dispersion medium mainly composed of the water-insoluble organic solvent, whereby the conductive fine particles are allowed to undergo interphase transfer from the aqueous dispersion medium phase to the organic dispersion medium phase (interphase transfer step). Specifically, after the organic dispersion medium is brought into contact with the aqueous dispersion medium, a compound such as amine is added so as to render the aqueous dispersion medium phase alkaline and moreover, the aqueous dispersion medium and the organic dispersion medium are heated to 50° C. to 90° C., whereby the aqueous dispersion medium and the organic dispersion medium are separated into two phases. In addition, due to reduction in hydration degree resulting from a hydrogen bonding of the oxygen atom in a polyether portion in the dispersant and a water molecule, water solubility is remarkably decreased, as a result, the water solubility in a portion derived from polyalkylene oxide (meth)acrylic acid derivative in the dispersant is decreased and the dispersant undergoes interphase transfer to the organic dispersion medium phase. Further, the conductive fine particles undergo interphase transfer to the organic dispersion medium phase by salting out and curing of organic acid salts formed from copper ions at the addition of a compound such as amine, or inorganic acid salts. As a result, the conductive fine particles are shielded from oxygen, that is, the conductive fine particles are hardly oxidized, unlike the case in the aqueous dispersion medium phase. In addition, the conductive fine particles are stably held in the organic dispersion medium phase in a dispersed state with the aid of a dispersion effect and a microbrownian motion by the dispersant.

Incidentally, in order to uniformly mix the aqueous dispersion medium and the organic dispersion medium, it is preferable to process them in an ultrasonic mixer in this interphase transfer step, whereby the aqueous dispersion medium and the organic dispersion medium form a uniform phase or a microemulsion. Herein, the microemulsion preferably has a particle size of 30 nm or less, more preferably 10 nm or less.

Next, the organic dispersion medium phase obtained by separating it from the aqueous dispersion medium phase as described above is taken out and washed with purified water (purification step), whereby water-soluble components dispersed in the organic dispersion medium, specifically, a part of the amine compound used as a reducing agent and the dispersant, and a neutralization salt are removed. As a result, conductive fine particles can be surely fused with each other by heating. The amount of the dispersant remaining in the organic dispersion medium after the purification step is preferably 20% by weight or less in terms of weight, based on copper. In this case, the conductive fine particles in the organic dispersion medium can be brought into contact with each other, so that a conductive pattern can be formed.

Next, the organic dispersion medium is evaporated and dried to solidify.

Further, the organic dispersion medium dried to solidify is mixed with a resin component and a curing agent and the resultant mixture is kneaded to produce the conductive pattern forming composition.

Next, a method for forming the conductive pattern of the present invention will be described.

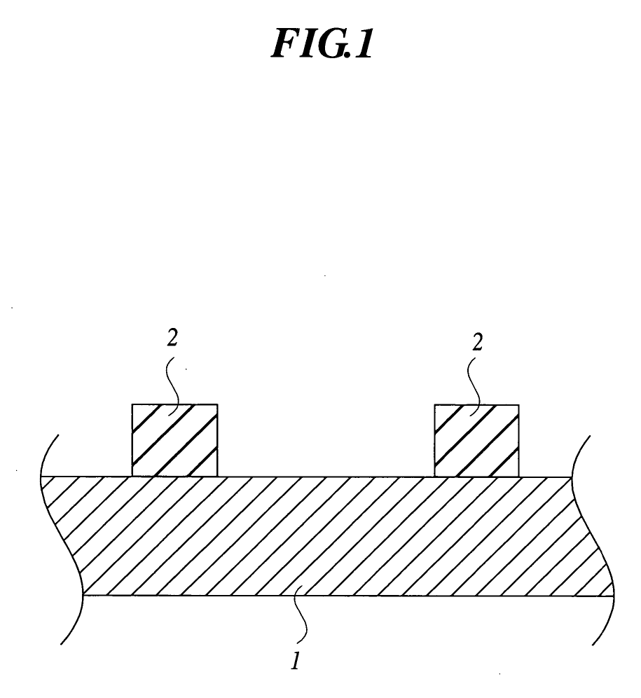

First, as shown in FIG. 1, a droplet pattern comprising droplets of the conductive pattern forming composition is drawn so as to have a predetermined lattice form on at least one surface of a film-like substrate 1 (drawing step). In the embodiment, it is described that droplets of the conductive pattern forming composition are ejected to form a droplet pattern by use of an ink jet system printer (not shown). The printer is provided with a recording head having a plurality of nozzles ejecting the conductive pattern forming composition. The nozzle of this recording head has a nozzle size of 0.1 μm to 10 μm and is designed so that the conductive pattern 2 formed due to the droplet pattern can have a line width of 20 μm or less. On the other hand, the conductive fine particle in the conductive pattern forming composition has a particle size of 0.1 nm to 20 nm and therefore, clogging in nozzles is hardly caused.

Then, heat is imparted to the drawn droplet pattern in which the droplet pattern is heated to 60° C. to 450° C. for from 1 minute to 60 minutes (heating step). As a result, the conductive fine particles in the droplet pattern are fused with each other, whereby the droplet pattern is formed into a conductive pattern 2. Herein, the reason of adjusting a heating temperature to 60° C. or more is that when the temperature is less than 60° C., organic materials are not sufficiently evaporated or burnt. Further, the reason of adjusting a heating temperature to 450° C. or less is that when the temperature exceeds 450° C., the conductive pattern 2 suffers from thermal damage. It is preferable that this heating step is carried out in a vacuum atmosphere or in an inactive gas atmosphere containing about 4% or less hydrogen, in order to prevent the oxidization of the conductive pattern.

According to the above-described conductive pattern forming composition, the fine conductive pattern 2 can be formed by use of minute conductive fine particles as compared with that in conventional techniques, so that a packaging density of the conductive pattern 2 on the substrate 1 can be increased.

Further, the conductive fine particle in the conductive pattern forming composition is made minute, so that by heating at a temperature lower than that in conventional techniques, conductivity can be imparted to the droplet pattern drawn on the surface of the substrate by droplets of the conductive pattern forming composition.

Further, the conductive fine particle is composed of copper, so that the conductive fine particle can be surely dispersed in the conductive pattern forming composition by use of the dispersant.

In the above-described embodiment, it is described that the conductive fine particle is composed of copper, however, the conductive fine particle may be composed of other metals such as gold, silver, ruthenium, rhodium, palladium, osmium, iridium or platinum.

Further, it is described that reduction is performed in the aqueous dispersion medium phase, however, the reduction may be performed in an emulsion comprising water and an organic solvent.

Further, it is described that formation of the conductive pattern is performed by use of the ink jet system, however, the formation may be performed by use of other system such as screen printing.

### EXAMPLES

Hereinafter, the present invention will be described in greater detail below by referring to the Examples. However, the present invention is not limited to these Examples.

In the Example, synthesis of a dispersant and production of copper fine particles, and two kinds of production of a conductive pattern forming composition and formation of a conductive pattern were carried out as described below. In the following description, values in parentheses indicate a ratio of weight.

<<Synthesis of Dispersant>>

First, isopropyl alcohol (100) as a solvent, monomer components of a dispersant and azoisobutyronitrile (1) as a polymerization initiator were put in a four-neck flask disposed in a water bath at 75° C. under a nitrogen flow, and they were subjected to solution polymerization. Employed as the monomer components were methyl methacrylate (30), stearyl methacrylate (10), methacrylic acid (ethylene oxide) 20 (propylene oxide) 5 terminal methoxy adduct (30), methacrylic acid (ethylene oxide) 120 (butylene oxide) 10 adduct (20) and dimethylaminoethyl methacrylate (10).

After the passing of 3 hours from the initiation of polymerization, azoisobutyronitrile (0.5) was further added.

After the passing of another 3 hours, azoisobutyronitrile (0.5) and laurylthio Kalcol (10) as a modifier were added, and they were subjected to solution polymerization for 2 hours.

A weight average molecular weight of the dispersant synthesized as described above was determined by use of a gel permeation chromatography (GPC). Employed as the column of the GPC apparatus was TKSgelSuper1000, TKSgelSuper2000 or TKSgelSuper3000 (manufactured by Tosoh Corporation), and determination was performed by utilizing a differential refractive index. As the carrier, tetrahydrofuran (THF) was employed. A determined weight average molecular weight was 35,000.

<<Production of Copper Fine Particle>>

First, copper nitrate (50) was dissolved in purified water (300) while stirring.

Next, the dispersant (10) synthesized as described above was added to the solution and uniformly dissolved.

Next, monoethanol amine (30) was slowly added to the solution while stirring over 30 minutes, whereby a copper ion was reduced to form a copper fine particle. A pH of the aqueous dispersion medium phase was adjusted to 8.5. Thereafter, the aqueous dispersion medium phase was continuously stirred while keeping it to 50° C. for 2 hours.

Next, ethyl acetate (100) as an organic dispersion medium was added to the aqueous dispersion medium and mixed using an ultrasonic mixer for 10 minutes, whereby the aqueous dispersion medium and the organic dispersion medium were formed into a microemulsion.

Next, the temperature of the microemulsion was raised to 60° C. while stirring over 20 minutes.

Next, by stopping the stirring, the microemulsion was allowed to stand still and separated into two phases of the aqueous dispersion medium phase and the organic dispersion medium phase having dispersed therein copper fine particles.

Next, the organic dispersion medium phase was taken out and washed twice with purified water (300) to obtain a liquid having dispersed therein copper fine particles with an average particle size of 8 nm.

<<Production of Conductive Pattern Forming Composition and Formation of Conductive Pattern (1)>>

First, the organic dispersion medium obtained as described above was evaporated and dried to solidify.

Next, the organic dispersion medium dried to solidify was mixed with resin components and a curing agent, and the mixture was kneaded by a three-roll mill to prepare a conductive pattern forming composition. More specifically, employed as resin components were bisphenol A type epoxy resin (Epicoat 828, manufactured by Yuka Shell Epoxy) and an epoxy resin obtained by converting a dimer acid into a glycidyl ester, (YD-171, manufactured by Tohto Chemical Industry Co., Ltd.)(hereinafter referred to as an epoxy resin derived from a dimer acid). Employed as the curing agent was Amineduct Curing Agent (MY-24, produced by Ajinomoto Co., Inc.). Further, in the above-described mixture, employed were 85% by weight of an organic dispersion medium dried to solidify, 3% by weight of a bisphenol A type epoxy resin, 9% by weight of an epoxy resin derived from a dimer acid and 3% by weight of Amineduct Curing Agent.

Next, the conductive pattern forming composition was screen printed on a glass epoxy substrate, and the resultant conductive pattern forming composition was heated at 150° C. for 20 minutes and heat-cured in an oven.

A formed conductive pattern had a line width of 30 μm and exhibited excellent conductivity such as a specific resistance of 7×10⁻⁵ Ω·cm.

<<Production of Conductive Pattern Forming Composition and Formation of Conductive Pattern (2)>>

First, the organic dispersion medium obtained as described above was evaporated and dried to solidify.

Next, the organic dispersion medium dried to solidify was mixed with isopropyl alcohol to prepare a conductive pattern forming composition. In the mixture, a ratio of the organic dispersion medium dried to solidify was adjusted to 25% by weight.

Next, the conductive pattern forming composition was ink jet-printed on a glass epoxy substrate and the resultant conductive pattern forming composition was heated at 150° C. for 20 minutes and heat-cured in an oven.

A formed conductive pattern had a line width of 10 μm and exhibited excellent conductivity such as a specific resistance of 8×10⁻⁵ Ω·cm.

The entire disclosure of Japanese Patent Application No. 2003-120092 filed on Apr. 24, 2003, including specification, claims, drawings and summary are incorporated herein by reference in its entirety.

What is claimed is:

1. A conductive pattern forming composition, containing in a dispersion medium conductive fine particles composed of at least one kind of metal and a dispersant for dispersing the conductive fine particles, wherein the dispersant is a polymer containing a tertiary amine-type monomer in a main chain and a polyether-type nonionic monomer in a side chain.

2. The composition of claim 1, for forming a conductive pattern on a surface of a substrate by an ink jet system.

3. The composition of claim 1, wherein the conductive fine particles comprise copper.

4. The composition of claim 1, wherein the conductive fine particles have an average particle size of not less than 0.1 nm and not more than 20 nm.

5. The composition of claim 1, wherein the dispersion medium is an organic dispersion medium mainly composed of a water-insoluble organic solvent.

6. A method for forming a conductive pattern comprising:
drawing a droplet pattern on a surface of a substrate by droplets of the composition of claim 1, and
heating the droplet pattern drawn in the drawing to impart conductivity to the droplet pattern.

7. The method of claim 6, wherein in the drawing, the droplet pattern is drawn by ejecting droplets of the conductive pattern forming composition by an ink jet system.

8. The method of claim 7, wherein in the drawing, the droplets of the conductive pattern forming composition are ejected from a nozzle having a nozzle size of 0.1 μm to 10 μm.

9. The method of claim 6, wherein in the drawing, a droplet pattern having a line width of 20 μm or less is drawn.

10. A method for producing a conductive pattern forming composition, comprising reducing a metal compound having at least one kind of metal in an aqueous dispersion medium containing a dispersant to obtain conductive fine particles, wherein a polymer containing a tertiary amine-type monomer in a main chain and a polyether-type nonionic monomer in a side chain is used as the dispersant.

11. The method of claim 10, wherein in the reducing, an organic amine compound is used as a reducing agent.

12. The method of claim 10, wherein in the reducing, a temperature of the aqueous dispersion medium is adjusted to 20° C. to 60° C.

13. The method of claim 10, further comprising: interphase transferring the conductive fine particles and the dispersant from an aqueous dispersion medium phase to an organic dispersion medium phase which is mainly composed of a water-insoluble organic solvent, after the reducing.

14. The method of claim 13, further comprising purifying to remove at least a part of water soluble components in the organic dispersion medium phase by use of purified water, after the interphase transferring.

15. A method for producing a conductive pattern forming composition, comprising interphase transferring a dispersant and conductive fine particles composed of at least one kind of metal from an aqueous dispersion medium phase containing the dispersant and having dispersed therein the conductive fine particles to an organic dispersion medium phase mainly composed of a water-insoluble organic solvent, wherein a polymer containing a tertiary amine-type monomer in a main chain and a polyether-type nonionic monomer in a side chain is used as the dispersant.

16. The method of claim 15, wherein in the interphase transferring, a temperature of the aqueous dispersion medium phase and the organic dispersion medium phase is adjusted to 50° C. to 90° C.

17. The method of claim 15, wherein in the interphase transferring, a pH of the aqueous dispersion medium is adjusted to 7 to 10.

18. The method of claim 15, further comprising purifying to remove at least a part of water soluble components in the organic dispersion medium phase by use of purified water, after the interphase transferring.
